(19) United States
(12) Patent Application Publication
(10) Pub. No.: US 2002/0175171 A1
(43) Pub. Date: Nov. 28, 2002

(54) Sealable food container with lid retaining sidewall shelf

(76) Inventors: Elizabeth Ann Walton Stewart, Darien, CT (US); Rebecca E. Whitmore, Chilton, WI (US); Mark B. Littlejohn, Appleton, WI (US); Margaret P. Neer, Neenah, WI (US); Debra D. Bowers, Menasha, WI (US); Jerome G. Dees, Appleton, WI (US); Gerald J. Van Handel, Neenah, WI (US)

Correspondence Address: Ferrell & Ferrell, L.L.P., Suite 401, 90 Crystal Run Road, Middletown, NY, 10941, US

(21) Appl. No.: 10/151,558

(22) Filed: May 20, 2002

Related U.S. Application Data
(63) Continuation-in-part of application No. 10/068,924, filed on Feb. 8, 2002.
Application No. 10/068,924 is a continuation-in-part of application No. 09/921,264, filed on Aug. 2, 2001.
(60) Provisional application No. 60/223,209, filed on Aug. 4, 2000.
(60) Provisional application No. 60/305,225, filed on Jul. 13, 2001.

(51) Int. Cl. B32B 1/02

(52) U.S. Cl. 220/781; 428/35.7; 220/4.24; 220/367.1; 219/735

(57) ABSTRACT

A sealable food container includes a base serving member such as a bowl with a generally planar central portion, a sidewall and a flange. The sidewall defines an annular sealing region with an annular sealing portion, a stop ridge and a laterally extending retaining shelf. A lid is provided with a peripheral portion adapted to be retained by the annular base sealing portion and to be secured by the stop ridge. In one preferred embodiment, the lid is a planar paperboard lid provided with a tab and the annular sealing portion of the base is an undercut groove in its sidewall.

### CROSS-REFERENCE TO RELATED APPLICATIONS

This application is a continuation-in-part of U.S. patent application Ser. No. 10/068,924, filed Feb. 8, 2002, entitled “A Sealable Food Container with Improved Lidding and Stacking Features” (Attorney Docket No. 2390; GP-01-33), which was a continuation-in-part of U.S. patent application Ser. No. 09/921,264, entitled “Disposable Serving Plate With Sidewall-Engaged Sealing Cover”, filed Aug. 2, 2001 (Attorney Docket No. 2242). U.S. patent application Ser. No. 09/921,264 was based on U.S. Provisional Application No. 60/223,209, filed Aug. 4, 2000 of the same title. This application also incorporates material in U.S. Provisional Patent Application No. 60/305,225, entitled “Crush-Resistant Disposable Lid”, filed Jul. 13, 2001 (Attorney Docket No. 2366). The priorities of the foregoing applications are hereby claimed.

### TECHNICAL FIELD

The present invention relates generally to food containers. In a preferred embodiment, there is provided a serving bowl with a sidewall-engaged planar sealing cover so as to provide for storage and transport as well as heating and serving of the contents.

### BACKGROUND

Sealable food containers are known in the art. Illustrative in this respect is U.S. Pat. No. 5,377,860 to Littlejohn et al. In the '860 patent there is disclosed a container having a base with an upwardly projecting sidewall integrally formed with a brim. The brim of the base is formed with a number of integral cooperating features including a reinforcing hoop and sealing surfaces. A lid is configured to fit the base and includes a dome as well as a lid brim configured to cooperate with the brim of the base. Thus, in accordance with the '860 patent there is provided a food container with a flexible brim seal between the lid and base which is provided by way of the respective brim designs. Food containers have also been made with planar lids, for example paperboard lids provided with a tab which are fitted to containers containing ice cream.

The present invention is likewise directed to a sealable food container, wherein the base is preferably in the form of a platter, bowl or plate provided with a sidewall and an arcuate flange portion as well as a sealing lid which engages the sidewall of the base. As such, the present invention provides improved graspability and utility as a food service article which may be used for heating and serving food.

### SUMMARY OF INVENTION

There is provided in accordance with the present invention a stackable food container including a base and a lid. In one preferred embodiment the base is a plastic bowl made from mineral-filled polypropylene with an undercut sidewall groove and a planar paperboard lid configured to fit into the sidewall groove. The groove is adjacent a laterally extending shelf which helps to position and retain the lid in its sealing position which is inwardly located with respect to the flange of the bowl. There is generally provided a sealable food container including a base serving member having a generally planar base central portion, a base sidewall extending generally upwardly and outwardly therefrom and a base outer flange portion extending outwardly from the base sidewall. The base sidewall defines a base sealing region with (i) an annular base sealing portion disposed between said substantially planar base central portion of the base serving member and the base outer flange portion, (ii) a base stop ridge adjacent an upper extremity of the annular base sealing portion as well as (iii) a laterally extending retaining shelf adjacent a lower extremity of the annular base scaling portion. A sealing lid of the container has a peripheral portion adapted to be retained by the annular base sealing region of the base serving member. Both the base serving member and the sealing lid are configured such that when the sealing lid is forced downwardly on the base serving member, the lid is positioned by the retaining shelf and secured to the base serving member by the base stop ridge. Typically, the annular base sealing portion is an undercut groove. Most preferably in some embodiments, the sealing lid is generally planar and includes a peripheral tab projecting generally outwardly from its periphery, as well as a vent which may be a hole located generally in the center of the planar lid. The lid may be a paperboard lid or a polymeric lid which may have a caliper of from about 10 to about 40 mils. The base serving member is preferably formed of a microwaveable thermoplastic material such as polypropylene, mineral-filled polypropylene, polyesters and mineral-filled polyesters and characteristic diameter to height ratio of at least about 2. A bowl having a diameter to height ratio of about 3.5 is described hereinafter.

The laterally extending retaining shelf of the base serving member generally extends outwardly over a base sidewall shelf length of at least about 0.5% of the characteristic diameter of the base serving member and typically extends outwardly over a base sidewall shelf length of at least about 1% of the characteristic diameter of the base serving member. In preferred embodiments, the laterally extending retaining shelf of the base serving member extends outwardly over a base sidewall shelf length of at least about 1.5% of the characteristic diameter of the base serving member. So also in preferred embodiments, the undercut annular base sealing portion of the base serving member includes a frustal sealing surface extending upwardly and outwardly with respect to the substantially planar base central portion of the base serving member, and the base outer flange of the base serving member is an arcuate outer flange.

Generally, the base serving member is formed from sheet thermoplastic material; for example, the base serving member is thermoformed, thermoformed by the application of vacuum or thermoformed by a combination of vacuum and pressure. The thermoplastic material may be a foamed or solid polymeric material selected from the group consisting of polyesters, polystyrenes, polypropylene, polyethylenes, copolymers and mixtures thereof. In one preferred embodiment, the base serving member has a wall thickness from about 10 to about 80 mils and consists essentially of from about 40 to about 90 percent by weight of a polypropylene polymer, from about 10 to about 60 percent by weight of a mineral filler, from about 1 to about 15 percent by weight polyethylene, up to about 5 weight percent titanium dioxide and optionally including a basic organic or inorganic compound comprising the reaction product of an alkali metal or alkaline earth element with carbonates, phosphates, carboxylic acids as well as alkali metal and alkaline earth element oxides, hydroxides, or silicates and basic metal oxides, including mixtures of silicon dioxide with one or more of the following oxides: magnesium oxide, calcium oxide, barium oxide, and mixtures thereof. Typically, the base serving member has a wall caliper of from about 10 to about 50 mils and preferably the base serving member has a wall caliper of from about 12 to about 25 mils.

These and other features of the present invention are further described in connection with the Figures attached hereto.

### BRIEF DESCRIPTION OF DRAWINGS

The present invention is described in connection with the various figures appended hereto wherein like numbers designate similar parts and wherein:

FIG. 1 is an exploded view in perspective showing a serving base member and sealing lid configured in accordance with the present invention;

FIG. 2 is a top view of the container of FIG. 1 wherein the sealing lid has been affixed to the serving base member;

FIG. 3 is a schematic detail along line 3-3 of FIG. 1 showing the geometry of the inventive sealing lid;

FIG. 4 is a schematic view along line 4-4 of FIG. 1 illustrating the profile of the inventive sealing lid along the centerline of a flute;

FIG. 5 is a schematic view along line 5-5 of FIG. 1 showing the profile of the flat portion of the sealing lid between the flutes in the sidewall of the lid of the containers;

FIG. 6 is a schematic diagram comparing the profile of the flat portions between flutes and the outwardly convex flutes about the periphery of the sealing lid of the inventive container;

FIG. 7 is an enlarged schematic detail illustrating the cooperation of the base serving member and the sealing lid to secure the inventive lid and base to one another and provide a sealed interior; and preferably, a substantially liquid proof seal;

FIG. 8 is a schematic diagram illustrating the cooperation of the inventive stacking features of the present invention to provide a secure stack of containers;

FIG. 9 is an exploded view in perspective of yet another sealable food container configured in accordance with the present invention;

FIG. 10 is a schematic view showing the profile from center of a bowl forming a base of the container of the present invention; and

FIG. 11 is an enlarged schematic view showing a portion of a planar lid secured to the sidewall of a container base.

### DETAILED DESCRIPTION

The present invention is described in detail below for purposes of exemplification and illustration, only. Modification of specific embodiments or variations thereof within the spirit and scope of the appended claims will be readily apparent to those of skill in the art. In general, the present invention is directed to a sealable food container and including a base such as a bowl, platter or a plate having a sidewall extending upwardly and outwardly from its central portion and a sealing lid configured to engage the sidewall. The materials from which the base and lid are made are also preferably selected so as to be suitable for heating or re-heating the contained food, for example, by way of a conventional or microwave oven or by heat lamps and so forth.

As used herein, terminology is given its ordinary meaning unless specifically otherwise defined. “Mils”, for example, refers to thousandths of an inch; caliper to wall thickness and “characteristic diameter” to the overall diameter of a container. That is to say, the characteristic diameter of a container base is the diameter across the outermost portion of the article for a generally circular article such as a bowl or plate. For other shapes, an average diameter may be used.

The containers of the invention are made by any suitable technique, typically, techniques employed for forming plastics or paper. The base or lid may thus be made from thermoplastic sheet which has been pre-cut or in the form of a continuous web or roll formed, thermoformed, thermoformed by the application of vacuum or thermoformed by a combination of vacuum and pressure into the products of the invention. Alternatively, the lid or base may be made from a plastic material by injection molding, injection blow molding, compression molding, injection stretch molding, composite injection molding and so forth. Thermoforming from plastic sheet is particularly preferred for the base.

In the simplest form, thermoforming is the draping of a softened sheet over a shaped mold. In the more advanced form, thermoforming is the automatic high speed positioning of a sheet having an accurately controlled temperature into a pneumatically actuated forming station whereby the article's shape is defined by the mold, followed by trimming and regrind collection as is well known in the art. Still other alternative arrangements include the use of drape, vacuum, pressure, free blowing, matched die, billow drape, vacuum snap-back, billow vacuum, plug assist vacuum, reverse draw with plug assist, pressure bubble immersion, trapped sheet, slip, diaphragm, twin-sheet cut sheet, twin-sheet roll-fed forming or any suitable combinations of the above. Details are provided in J. L. Throne's book, Thermoforming, published in 1987 by Coulthard. Pages 21 through 29 of that book are incorporated herein by reference. Suitable alternate arrangements also include a pillow forming technique which creates a positive air pressure between two heat softened sheets to inflate them against a clamped male/female mold system to produce a hollow product. Metal molds are etched with patterns ranging from fine to coarse in order to simulate a natural or grain-like texturized look. Suitable formed articles are trimmed in line with a cutting die and regrind is optionally reused since the material is thermoplastic in nature. Other arrangements for productivity enhancements include the simultaneous forming of multiple articles with multiple dies in order to maximize throughput and minimize scrap.

A particularly preferred material for a bowl, plate or platter is mica-filled polypropylene, optionally provided with calcium carbonate, polyethylene and titanium dioxide in suitable amounts as hereinafter described. The sealing lid may be a planar paperboard lid or polymeric lid as described hereinafter. A paperboard lid may be coated with a filled or pigmented composition as is well known in the art. Alternatively, other suitable materials for the lid include laminates to paperboard or polymer substrates, for instance, foils laminated to paperboard.

A platter, bowl or plate of the food container of the present invention may be produced utilizing polymeric compositions filled with conventional inorganic fillers such as talc, mica, wollastonite and the like, wherein the polymer component is, for example, a polyester, a polystyrene homopolymer or copolymer, a polyolefin or one or more of the polymers noted above. While any suitable polymer may be used, polypropylene polymers which are suitable for the plate, bowl or platter are preferably selected from the group consisting of isotactic polypropylene, and copolymers of propylene and ethylene wherein the ethylene moiety is less than about 10% of the units making up the polymer, and mixtures thereof. Generally, such polymers have a melt flow index from about 0.3 to about 4, but most preferably the polymer is isotactic polypropylene with a melt-flow index of about 1.5. In some preferred embodiments, the melt-compounded composition from which the articles are made may include polypropylene and optionally further includes a polyethylene component and titanium dioxide. A polyethylene polymer or component may be any suitable polyethylene such as HDPE, LDPE, MDPE, LLDPE or mixtures thereof and may be melt-blended with polypropylene if so desired.

The various polyethylene polymers referred to herein are described at length in the Encyclopedia of Polymer Science & Engineering (2d Ed.), Vol. 6; pp: 383-522, Wiley 1986; the disclosure of which is incorporated herein by reference. HDPE refers to high density polyethylene which is substantially linear and has a density of generally greater that 0.94 up to about 0.97 g/cc. LDPE refers to low density polyethylene which is characterized by relatively long chain branching and a density of about 0.912 to about 0.925 g/cc. LLDPE or linear low density polyethylene is characterized by short chain branching and a density of from about 0.92 to about 0.94 g/cc. Finally, intermediate density polyethylene (MDPE) is characterized by relatively low branching and a density of from about 0.925 to about 0.94 g/cc.

Typically, in filled plastics useful for making the plate or container base of the food container the primary mineral filler is mica, talc, kaolin, bentonite, wollastonite, milled glass fiber, glass beads (solid or hollow), silica, or silicon carbide whiskers or mixtures thereof. We have discovered that polypropylene may be melt-compounded with acidic-type minerals such as mica, as well as inorganic materials and/or basic materials such as calcium carbonate. Other fillers include talc, barium sulfate, calcium sulfate, magnesium sulfate, clays, glass, dolomite, alumina, ceramics, calcium carbonate, silica, pigments such as titanium dioxide based pigments and so on. Many of these materials are enumerated in the Encyclopedia of Materials Science and Engineering, Vol. #3, pp. 1745-1759, MIT Press, Cambridge, Mass. (1986), the disclosure of which is incorporated herein by reference. Combinations of fillers are preferred in some embodiments.

Mineral fillers are sometimes referred to by their chemical names. Kaolins, for example, are hydrous alumino silicates, while feldspar is an anhydrous alkalialumino silicate. Bentonite is usually an aluminum silicate clay and talc is hydrated magnesium silicate. Glass, or fillers based on silicon dioxide may be natural or synthetic silicas. Wollastonite is a calcium metasilicate whereas mica is a potassium alumino silicate. Clays may be employed as a primary filler; the two most common of which are kaolin and bentonite. Kaolin refers generally to minerals including kaolinite which is a hydrated aluminum silicate (Al₂O₃.2SiO₂.2H₂O) and is the major clay mineral component in the rock kaolin. Kaolin is also a group name for the minerals kaolinite, macrite, dickite and halloysite. Bentonite refers to hydrated sodium, calcium, iron, magnesium, and aluminum silicates known as montmorillonites which are also sometimes referred to as smectites.

Fillers commonly include: barium salt; barium ferrite; barium sulfate; carbon/coke powder; calcium fluoride; calcium sulfate; carbon black; calcium carbonate; ceramic powder; chopped glass; clay; continuous glass; glass bead; glass fiber; glass fabric; glass flake; glass mat; graphite powder; glass sphere; glass tape; milled glass; mica; molybdenum disulfide; silica; short glass; talc; whisker. Particulate fillers, besides mica, commonly include: glass; calcium carbonate; alumina; beryllium oxide; magnesium carbonate; titanium dioxide; zinc oxide; zirconia; hydrated alumina; antimony oxide; silica; silicates; barium ferrite; barium sulphate; molybdenum disulfide; silicon carbide; potassium titanate; clays. Fibrous fillers are commonly: whiskers; glass; mineral wool; calcium sulphate; potassium titanate; boron; alumina; sodium aluminum hydroxy carbonate.

As noted above, a mica-filled polypropylene polymer composition is particularly preferred for forming the base (bowl or plate) portion of the container.

The lid portion of the present invention may be formed of any of the materials described above, and is in some embodiments perhaps most preferably made from paperboard coated with a filled or pigmented composition including a mineral such as titanium dioxide, clays such as kaolin and a binder resin such as a vinyl resin.

The sealable containers according to the present invention may have any particular size and shape as desired so long as the relative base and lid features are present. More specifically, square or rectangular with rounded corners, triangular, oval, multi-sided, polyhedral, and similar shapes may be made having the profile described above including plates, bowls, platters, and common lidding features such as 6 1/16-inch and 12 oz., 7 5/16-inch and 20 oz. plates and bowls. In various embodiments of the present invention the container may be 6 1/16-inch, 7 5/16-inch, 9-inch, 10¼-inch and 11-inch plates and so forth. The container may include a compartmented base in the form of a plate of the class described in co-pending U.S. patent application Ser. No. 09/354,706, filed Jul. 16, 1999, entitled “Compartmented Disposable Plate With Asymmetric Rib Geometry”, (Attorney Docket No. 2195; FJ-99-10), now U.S. Pat. No. ______, the disclosure of which is hereby incorporated by reference.

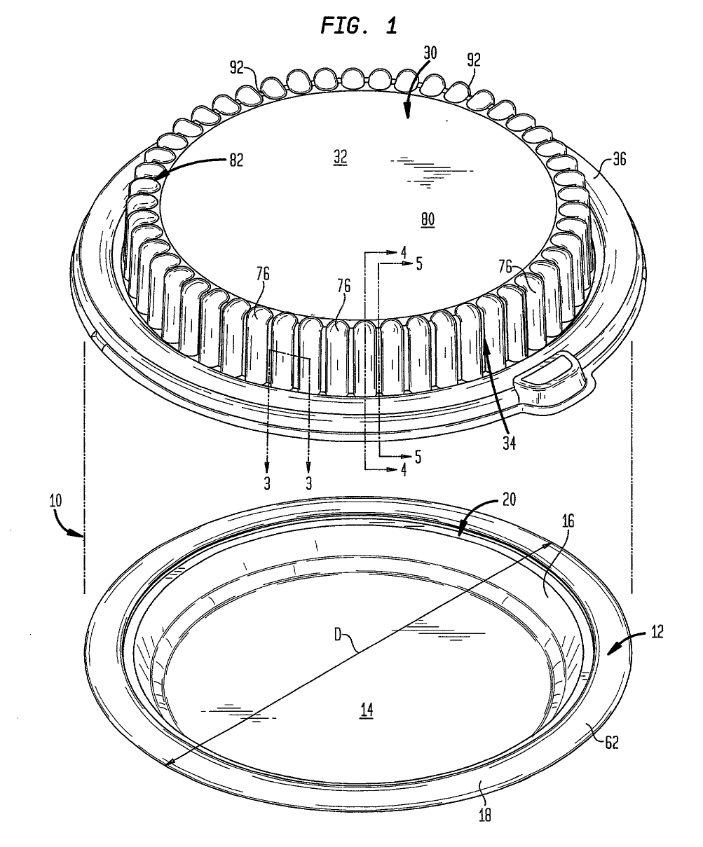

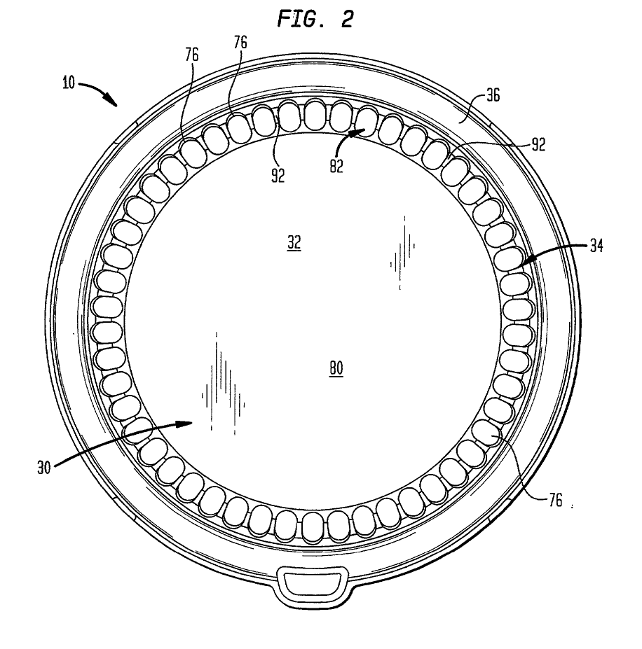

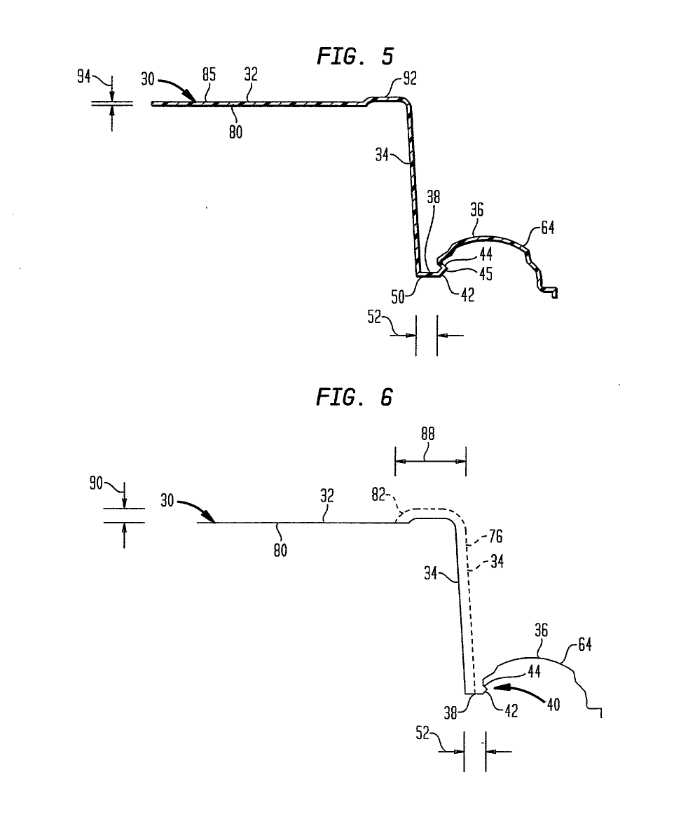

Referring to FIGS. 1-8 there is shown a sealable food container 10 including a plate 12 having a generally planar central portion 14, a plate sidewall 16 extending generally upwardly and outwardly therefrom and a plate outer flange portion 18 extending outwardly from the sidewall. The planar central portion or bottom 14 of the plate may be provided with a slight crown if so desired as is known in the art to prevent rocking when the container is placed on a flat surface. The plate is generally circular with a characteristic diameter, D which may be, for example, about 10¼ inches and have a circumference around its sealing area of between 25 and 30 inches or so; that is, the diameter of the stop ridge about its lower edge in the sidewall may be about 8⅝ inches for a plate with a characteristic diameter of 10¼inches.

Sidewall 16 defines a sealing portion 20 with an undercut annular sealing surface 22 disposed between the substantially planar central portion 14 of plate 12 and the plate outer flange portion 18. Sidewall sealing portion 20 defines a base stop ridge 24 at the upper edge 26 of the undercut annular sealing surface 22 of the sidewall. There is further defined by the sidewall a laterally extending retaining shelf 28 adjacent to undercut annular sealing surface 22. Shelf 28 is generally horizontal (parallel to planar portion 14) and located adjacent lower edge 29 of annular plate sealing surface 22 as shown. Shelf 28 has a shelf length 31 over the generally horizontal span between edge 29 of surface 22 and an inner edge 27 of shelf 28.

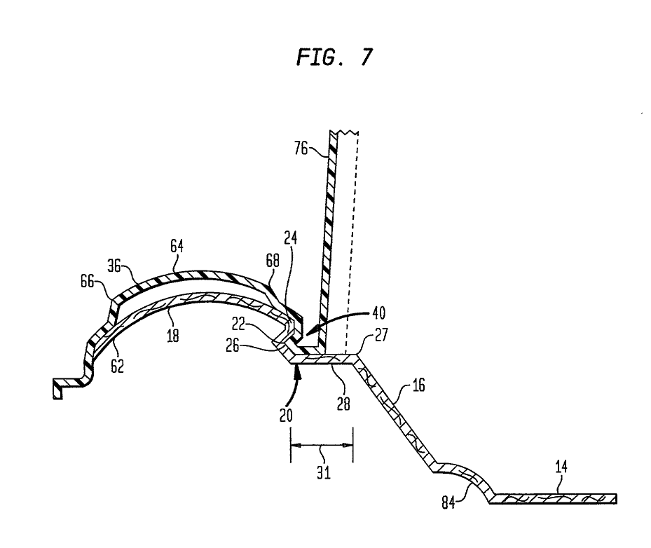

Container 10 also includes a sealing lid 30 provided with a lid dome portion 32, a flexible lid sidewall 34 extending downwardly from dome portion 32. Both the flat portion of sidewall 34 and fluted portion of sidewall 34 are shown in FIG. 6. The lid also has a lid flange portion 36 extending outwardly with respect to the downwardly extending lid sidewall. The lid flange portion includes at its inner periphery 38 a lid sealing portion 40. Lid sealing portion 40 defines a frustal sealing surface 42 extending upwardly and outwardly with respect to the downwardly extending sidewall of the sealing lid. Lid sealing portion 40 also defines a lid stop ridge 44, generally adjacent an upper edge 45 of surface 42. The plate and the sealing lid are configured such that when the sealing lid is forced downwardly on plate 12 sealing lid 30 is secured to the base serving member by cooperation of base stop ridge 24 and lid stop ridge 44.

Laterally extending retaining shelf 28 of plate 12 extends outwardly over a base shelf length 31 which is generally at least about 0.5% of the characteristic diameter D of plate 12. The characteristic diameter of the container is taken as the diameter, for example, of the base serving member in the case of a round plate as shown. With respect to other shapes that may be employed in accordance with the present invention, the characteristic diameter of the base serving member such as a plate or platter is taken as the average dimension across the base, for example, for a rectangular or polygonal shape, one simply would take a mean span across the article from one outer edge to its opposite outer edge across the middle of the article.

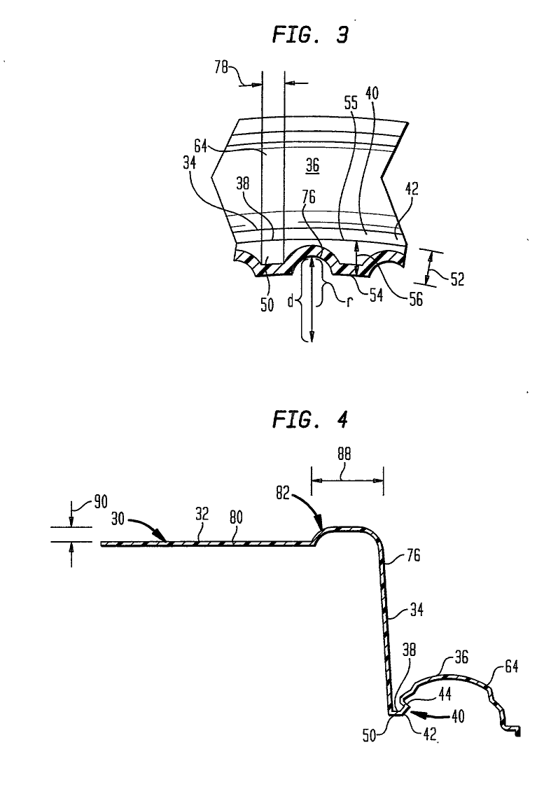

Referring in particular to FIGS. 3 and 5-7, the sealing lid is preferably provided with a laterally extending lid shelf 50 extending between flexible sidewall 34 of the sealing lid and the annular sealing surface 42 of lid 30. Lid shelf 50 extends outwardly over a lid shelf radial span 52 and is adapted to cooperate with the retaining shelf of plate 12 to position the sealing lid with respect to the base. It should be noted as used herein, the term “lid shelf radial span” refers to maximum span 52 from an inner edge 54 of the shelf to an outer edge 55 of lid shelf 50 such that in the case of a lid stop shelf that has a fluted or scalloped inner edge, the lid stop shelf radial span 52 is the maximum distance between inner edge 54 of the lid stop shelf and the upwardly and outwardly extending annular sealing surface 42 of sealing portion 40, as is shown at 56, for example. As noted above, the length of the lid shelf radial span is typically at least about 25% of base sidewall shelf length 31. Preferably the lid shelf radial span is greater than that.

In preferred embodiments, undercut sealing surface 22 of plate 12 is a frustal sealing surface extending upwardly and outwardly with respect to substantially planar central portion 14 of plate 12. Annular sealing portion 40 of sealing lid 30 also preferably includes a frustal configuration of sealing surface 42 extending upwardly and outwardly with respect to the downwardly extending sidewall of sealing lid 30.

Preferably base stop ridge 24 is located adjacent the upper edge of sealing surface 22 of sidewall 16 of plate 12; whereas lid stop ridge 44 is located adjacent the upper edge of sealing surface 42 of the lid. The lid is dimensioned so as to outwardly flexibly urge its frustal sealing surface 42 into surface to surface contact with frustal sealing surface 22 of plate 12 (also in a frustal configuration) when plate and sealing lid 30 are secured to one another.

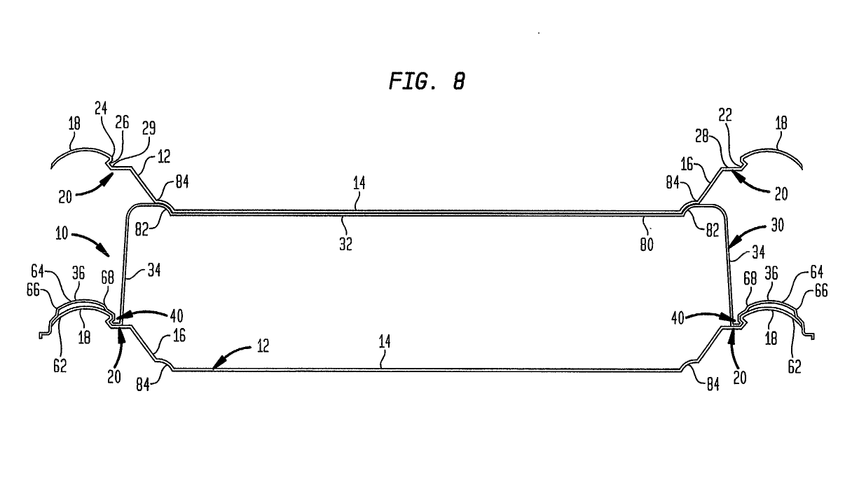

Both the base serving member, typically a plate, and sealing lid may be provided with an arcuate outer flange. Outer arcuate flange 62 of plate 12 is generally arcuate in shape typically having a radius of curvature which is more or less constant. On the other hand, arcuate outer flange 64 of sealing lid 30 may have a plurality of ridges such as ridges 66 and 68 in its profile if so desired. In any case, sealing lid outer flange 64 is generally configured to overlay arcuate outer flange 62 of the plate as shown particularly in FIGS. 7 and 8.

Flexible sidewall 34 of sealing lid 30 is provided with a plurality of outwardly convex flutes 76 formed in the sidewall. Typically lid 30 includes about 3 or fewer flutes per inch of engagement perimeter, that is the circumferential length about the lower edge of base stop ridge 24 which is also approximately the circumferential distance about upper edge 45 of annular surface 42.

As shown in FIG. 3, flutes 76 have a characteristic cylindrical diameter, d, which is twice the radius of curvature, r, of the inner surface of the sidewall. As noted above this diameter is typically less than about 0.75 inches.

As will be appreciated from the Figures the outwardly convex flutes are typically circumferentially spaced apart from one another. The outwardly convex flutes are spaced apart a distance 78 (FIG. 3) generally from about 0.05 to about 0.25 inches about the periphery of the lid. So also, the convex flutes project upwardly with respect to generally planar upper surface portion 80 of dome 32 of the sealing lid and define a generally upwardly convex and generally inwardly retaining ridge upper profile 82 as can be seen in the various Figures.

Plate 12 is provided with an annular sidewall stacking recess 84 adjacent generally planar bottom portion 14 at the lower portion of sidewall 16. Recess 84 is adapted to engage generally convex retaining ridge profile 82 of the sealing lid in order to render a plurality of sealable food containers securely stackable with one another as is seen best in FIG. 8.

Typically the upwardly convex retaining ridge profile adjacent the upper, generally planar portion 80 of the sealing lid comprises a plurality of spaced arcuate flute profiles 76 extending inwardly from the outer periphery of the container. The inward extension length 88 (FIGS. 4, 6) of the flutes inwardly adjacent planar portion 80 of dome 32 may be of any suitable length; but typically at least about 0.2 and preferably at least about 0.3 inches in preferred embodiments.

The flutes may have a flute height 90 above generally planar upper surface 85 of dome 32 of greater than about 0.075 inches. In the embodiments shown, there are provided a plurality of flat portions 92 between the upwardly extending flutes 76 having a flat portion height 94 of generally greater than about 0.01 inches. The relative profiles of the flutes and flat portions there between are perhaps best appreciated by reference to FIGS. 4 through 6.

It should be appreciated by reference to FIG. 3, that lid shelf 50 of lid 30 is typically a fluted lid shelf. Radial span 52 is indicated on FIG. 3 as noted above.

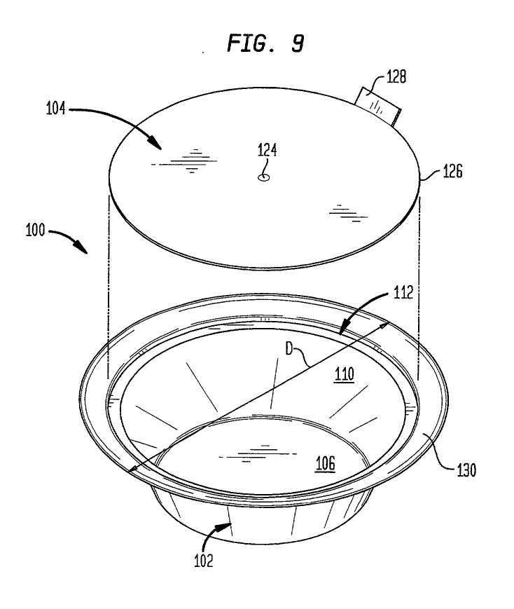

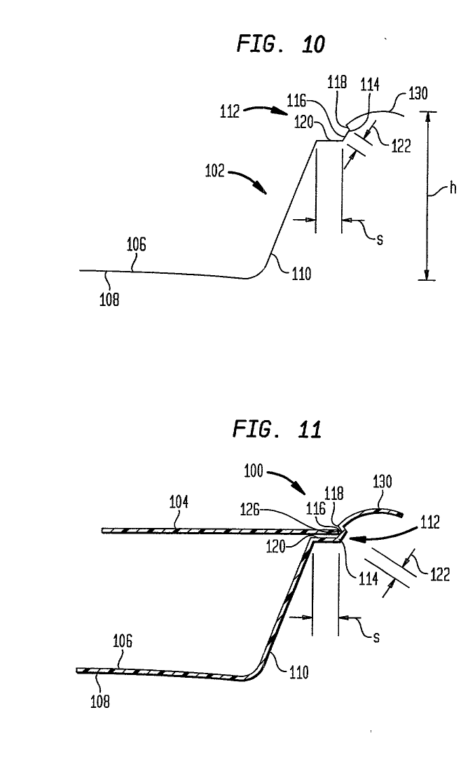

There is illustrated in FIGS. 9-11 another container configured in accordance with the present invention.

Container 100 includes generally a thermoformed base such as bowl 102 and a lid, such as planar paperboard lid 104. Bowl 102 includes a generally planar base central portion 106 which may have a slight crown indicated at 108 if so desired. The planar central portion transitions to a sidewall 110 which defines a sealing region 112. There is provided as part of the sealing region an annular sealing portion 114 preferably including a frustoconical surface 116 adjacent a stop ridge 118 at the upper extremity of the sealing portion.

The sealing region further includes a laterally extending retaining shelf 120 adjacent he lower edge of the sealing portion.

It will be appreciated from the diagrams that the sealing portion is most preferably in the form of an undercut sidewall groove configured to secure paperboard lid 104 as shown schematically in FIG. 11.

The bowl may have a diameter, D, of 6¼″ or so and a height, h, of about 1¾″ if so desired. The laterally extending shelf has a shelf width, s, is typically about ⅛″, such that the ratio h:s is less than about 20, typically less than about 15 and less than 10 for containers wherein the base is a plate, for example. Frustoconical surface 116 typically extends upwardly and outwardly a distance 122 which is less than distance, s, typically about ½ s or so.

Paperboard lid 104 is provided with a hole 124 generally centrally located in the lid as shown in FIG. 9. Hole 124 acts as a vent for steam when the contents of the container are heated. The paperboard lid is configured such that its periphery 126 engages frustoconical surface 116 and may include a tab 128 so that the lid is easily removed. That is, one could simply grasp the outer arcuate flange 130 of bowl 102 and pull on tab 128 to disengage the lid from the container. When surface 116 extends over a distance 122 of 1/16″ or thereabouts, paperboard lid 104 may have a caliper of 10-40 mils or so.

Shelf 120 extends over a substantial distance, s, so it retains lid 104; that is to say, bowl 102 is placed on a flat surface and lid 104 is pressed downwardly so that it is positioned by shelf 120 and prevented from continuing downwardly. When thus engaged to bowl 102, stop ridge 118 secures the lid in position as shown in FIG. 11.

While the invention has been described in detail, various modifications to the specific embodiment illustrated will be readily apparent to those of skill in the art. For example, one could produce a container with additional features such as additional ridges and so forth. Such modifications are within the spirit and scope of the present invention defined in the appended claims.

What is claimed is:

1. A sealable food container comprising:
(a) a base serving member having a generally planar base central portion, a base sidewall extending generally upwardly and outwardly therefrom and a base outer flange portion extending, outwardly from said base sidewall;
said base sidewall defining a basic sealing region with (i) an annular base scaling portion disposed between said substantially planar base central portion of said base serving member and said base outer flange portion, (ii) a base stop ridge adjacent an tipper extremity of said annular base sealing portion as well as (iii) a laterally extending retaining shelf adjacent a lower extremity of said annular base sealing portion; and
(b) a scaling lid provided with a peripheral portion adapted to be retained by the annular base sealing region of the base serving member,
wherein said base serving member and the said sealing lid are configured such that when the sealing lid is forced downwardly on the base serving member, the lid is positioned by the retaining shelf and secured to the base serving member by the base stop ridge.

2. The food container according to claim 1, wherein said annular base scaling portion is an undercut groove.

3. The food container according to claim 1, wherein said sealing lid is generally planar.

4. The food container according to claim 3, wherein said lid comprises a peripheral tab projecting generally outwardly from its periphery.

5. The food container according to claim 3, wherein said lid further comprises a vent.

6. The food container according to claim 5, wherein said vent comprises a hole located generally in the center of said planar lid.

7. The food container according to claim 3, wherein said lid is a paperboard lid.

8. The food container according to claim 7, wherein said paperboard lid has a caliper of from about 10 to about 40 mils.

9. The food container according to claim 7, wherein said lid comprises a vent and said base serving member is formed of a microwaveable thermoplastic material.

10. The food container according to claim 9, wherein said microwaveable material is selected from the group consisting of polypropylene, mineral-filled polypropylene, polyesters and mineral-filled polyesters.

11. The food container according to claim 1, wherein said base serving member has a characteristic diameter to height ratio of at least about 2.

12. The food container according to claim 11, wherein said base serving member is a bowl having a diameter to height ratio of about 3.5.

13. The food container according to claim 1, wherein said laterally extending retaining shelf of said base serving member extends outwardly over a base sidewall shelf length of at least about 0.5% of the characteristic diameter of said base serving member.

14. The food container according to claim 13, wherein said laterally extending retaining shelf of said base serving member extends outwardly over a base sidewall shelf length of at least about 1% of the characteristic diameter of said base serving member.

15. The food container according to claim 14, wherein said laterally extending retaining shelf of said base serving member extends outwardly over a base sidewall shelf length of at least about 1.5% of the characteristic diameter of said base serving member.

16. The food container according to claim 1, wherein said undercut annular base sealing portion of said base serving member includes a frustal sealing surface extending upwardly and outwardly with respect to said substantially planar base central portion of said base serving member.

17. The food container according to claim 1, wherein said base outer flange of said base serving member is an arcuate outer flange.

18. The food container according to claim 1, wherein said base serving member is formed from sheet thermoplastic material.

19. The food container according to claim 18, wherein said base serving member is thermoformed, thermoformed by the application of vacuum or thermoformed by a combination of vacuum and pressure.

20. The food container of claim 19, wherein said thermoplastic material comprises a foamed or solid polymeric material selected from the group consisting of:
polyesters, polystyrenes, polypropylenes, polyethylenes, copolymers and mixtures thereof.

21. The food container according to claim 20, wherein said base serving member is thermoformed from mineral-filled polypropylene sheet.

22. The food container according to claim 21, wherein said base serving member has a wall thickness from about 10 to about 80 mils and consists essentially of from about 40 to about 90 percent by weight of a polypropylene polymer, from about 10 to about 60 percent by weight of a mineral filler, from about 1 to about 15 percent by weight polyethylene, up to about 5 weight percent titanium dioxide and optionally including a basic organic or inorganic compound comprising the reaction product of an alkali metal or alkaline earth element with carbonates, phosphates, carboxylic acids as well as alkali metal and alkaline earth element oxides, hydroxides, or silicates and basic metal oxides, including mixtures of silicon dioxide with one or more of the following oxides: magnesium oxide, calcium oxide, barium oxide, and mixtures thereof.

23. The food container according to claim 18, wherein said base serving member has a wall caliper of from about 10 to about 50 mils.

24. The food container according to claim 23, wherein said base serving member has a wall caliper of from about 12 to about 25 mils.

25. A sealable food container comprising:
(a) a thermoformed base serving member having a generally planar base central portion, a base sidewall extending generally upwardly and outwardly therefrom and a base arcuate outer flange portion extending outwardly from said base sidewall, the base serving member having an overall height, h;
said base sidewall defining a base sealing region with (i) an annular base sealing portion disposed between said substantially planar base central portion of said base serving member and said base outer flange portion, (ii) a base stop ridge adjacent an upper extremity of said annular base sealing portion as well as (iii) a laterally extending retaining shelf adjacent a lower extremity of said annular base sealing portion having a shelf length, s; and
(b) a generally planar sealing lid provided with a peripheral portion adapted to be retained by the annular base sealing region of the base serving member,
wherein said base serving member and the said sealing lid are configured such that when the sealing lid is forced downwardly on the base serving members the lid is positioned by the retaining shelf and secured to the base serving member by the base stop ridge, and wherein the ratio of the overall height, h, to the shelf length, s, is less than about 20.

26. The food container according to claim 25, wherein said annular base sealing portion is an undercut groove.

27. The food container according to claim 25, wherein the ratio h:s is less than about 15.

28. The food container according to claim 27, wherein the ratio h:s is less than about 10.

29. The food container according to claim 25, wherein said lid comprises a peripheral tab projecting generally outwardly from its periphery.

30. The food container according to claim 25, wherein said lid further comprises a vent.

31. The food container according to claim 25, wherein said lid is a paperboard lid.

32. The food container according to claim 25, wherein said paperboard lid has a caliper of from about 10 to about 40 mils.

33. The food container according to claim 25, wherein said lid comprises a vent and said base serving member is formed of a microwaveable thermoplastic material.

34. The food container according to claim 33, wherein said microwaveable material is selected from the group consisting of polypropylene, mineral-filled polypropylene, polyesters and mineral-filled polyesters.

35. The food container according to claim 25, wherein said base serving member has a characteristic diameter to height ratio of at least about 2.

36. The food container according to claim 25, wherein said base serving member has a wall caliper of from about 10 to about 50 mils.

37. The food container according to claim 36, wherein said base serving member has a wall caliper of from about 12 to about 25 mils.
